(19) United States
(12) Patent Application Publication
(10) Pub. No.: US 2018/0281797 A1
(43) Pub. Date: Oct. 4, 2018

(54) SETTINGS ADJUSTMENTS OF OFF-ROAD VEHICLES

(71) Applicant: Ford Global Technologies, LLC, Dearborn, MI (US)

(72) Inventors: David Jeffeory Berels, Plymouth, MI (US); Douglas B. Thornburg, Dearborn, MI (US)

(21) Appl. No.: 15/479,102

(22) Filed: Apr. 4, 2017

(51) Int. Cl. B60W 30/182; B60G 17/0165; B60G 17/018; B60K 17/344; B60W 10/16; B60W 10/22; B60W 30/02; G01C 21/36; G01S 19/13

(52) U.S. Cl. CPC B60W 30/182; B60G 17/0165; B60G 17/0182; B60K 17/344; B60K 35/00; B60W 10/22; B60W 30/02; G01C 21/3691; G01S 19/13; B60W 10/16

(57) ABSTRACT

Method and apparatus are disclosed for settings adjustments of off-road vehicles. An example vehicle includes a locking differential, a suspension, a communication module to collect a map of an off-road trail, and a GPS receiver to determine a vehicle location. The example vehicle also includes an obstacle identifier to detect, via a processor, an upcoming obstacle based upon the vehicle location on the map, and a mode adjuster to set the locking differential in a first setting and the suspension in a second setting based upon the upcoming obstacle.

### TECHNICAL FIELD

The present disclosure generally relates to off-road vehicles and, more specifically, vehicle settings adjustments on off-road trails.

### BACKGROUND

Typically, land vehicles (e.g., cars, trucks, buses, motorcycles, etc.) are capable of traveling on a paved or gravel surface. Some land vehicles are off-road vehicles that are capable of traveling on unpaved and non-gravel surfaces. In some instances, off-road vehicle include large wheels with large treads, a body that sits high above a ground surface and/or a powertrain that produces increased torque or traction to enable the off-road vehicle to travel along the unpaved and non-gravel surfaces. Off-road vehicles oftentimes are utilized for sporting, agricultural, or militaristic purposes. For example, there are many publicly or commercially accessible off-road trails, paths, tracks and/or parks that enable all-terrain vehicle enthusiasts to drive their off-road vehicles on natural or man-made off-road terrain.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for settings adjustments of off-road vehicles. An example disclosed vehicle includes a locking differential, a suspension, a communication module to collect a map of an off-road trail, and a GPS receiver to determine a vehicle location. The example disclosed vehicle also includes an obstacle identifier to detect, via a processor, an upcoming obstacle based upon the vehicle location on the map, and a mode adjuster to set the locking differential in a first setting and the suspension in a second setting based upon the upcoming obstacle.

An example disclosed method for adjusting vehicle settings of off-road vehicles includes collecting a map of an off-road trail via a communication module of a vehicle and determining a vehicle location via a GPS receiver. The example disclosed method also includes detecting, via a processor, an upcoming obstacle based upon the vehicle location on the map and setting, via the processor, a locking differential in a first setting and a suspension in a second setting based upon the upcoming obstacle.

An example disclosed system includes a vehicle including a locking differential, a suspension, a communication module, and a processor. The example disclosed system also includes a trail server to determine a vehicle location on a map of an off-road trail and detect an upcoming obstacle based on the vehicle location. The trail server also is to send, based on the upcoming obstacle, a signal to the communication module to cause the processor to set the locking differential in a first setting and the suspension in a second setting.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example off-road vehicle in accordance with the teachings disclosed herein.

FIG. 2 illustrates a powertrain of the off-road vehicle of FIG. 1.

FIG. 3 is a block diagram of components of an example vehicle settings adjustment system the off-road vehicle of FIG. 1.

FIG. 4 is a block diagram of electronic components of the off-road vehicle of FIG. 1.

FIG. 5 is a flowchart for adjusting settings of the off-road vehicle of FIG. 1 in accordance with the teachings disclosed herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Typically, land vehicles (e.g., cars, trucks, buses, motorcycles, etc.) are capable of traveling on a paved or gravel surface. Some land vehicles are off-road vehicles that are capable of traveling on unpaved and non-gravel surfaces. In some instances, off-road vehicle include large wheels with large treads, a body that sits high above a ground surface and/or a powertrain that produces increased torque or traction to enable the off-road vehicle to travel along the unpaved and non-gravel surfaces. Off-road vehicles oftentimes are utilized for sporting, agricultural, or militaristic purposes.

There are many publicly or commercially accessible off-road trails, paths, tracks and/or parks that enable all-terrain vehicle enthusiasts to drive their off-road vehicles on natural or man-made off-road terrain. The off-road trails, paths, tracks and/or parks may include hills, loose sand, mud holes, lateral inclines, and/or other obstacles. Generally, an off-road vehicle includes various vehicle components that facilitate the off-road vehicle in traveling past, though, and/or over the off-road obstacles. Each of the vehicle components may include different settings that facilitate the off-road vehicle to traverse through different off-road obstacles. For example, the vehicle settings that facilitate the off-road vehicle in traversing through a mud hole may be different than the vehicle settings that facilitate the off-road vehicle in traversing over a hill.

In some instances, a driver of an off-road vehicle may be unfamiliar with obstacles of off-road trail and/or may be unfamiliar with current conditions of those obstacles. For example, a driver of an off-road vehicle may be unfamiliar with obstacles of a new trail and/or may be unaware as to how recent weather conditions have affected the obstacles of the trail. In such instances, it potentially may be difficult for a driver to know the vehicle settings of the off-road vehicle that will facilitate the off-road vehicle in traversing through the obstacles of the off-road trail. Further, in instances in which the off-road trail includes a number of different types of obstacles, it potentially may be difficult to identify and/or adjust the settings of the vehicle components for each of the obstacles of the off-road trail.

The examples apparatus and methods disclosed herein include an off-road vehicle that identifies upcoming obstacles of off-road trails for the off-road vehicle, determines settings of vehicle components that facilitate the off-road vehicle in traversing through the upcoming obstacles, and autonomously sets and/or provides instructions to facilitate a driver in adjusting settings of the vehicle components while driving the off-road vehicle on the off-road trail. That is, the example apparatus and methods enables dynamic adjustment of settings of vehicle components while the off-road vehicle is travelling on the off-road trail to enable the vehicle component settings to be adjusted for different obstacles without stopping the off-road vehicle before each obstacle to make adjustments to the vehicle component settings. As used herein, an “off-road vehicle” and an “all-terrain vehicle” refer to a vehicle that is capable of driving on an unpaved or non-gravel surface as well as a paved or gravel surface. Example off-road vehicles include trucks, sports utility vehicles, four-wheelers, etc.

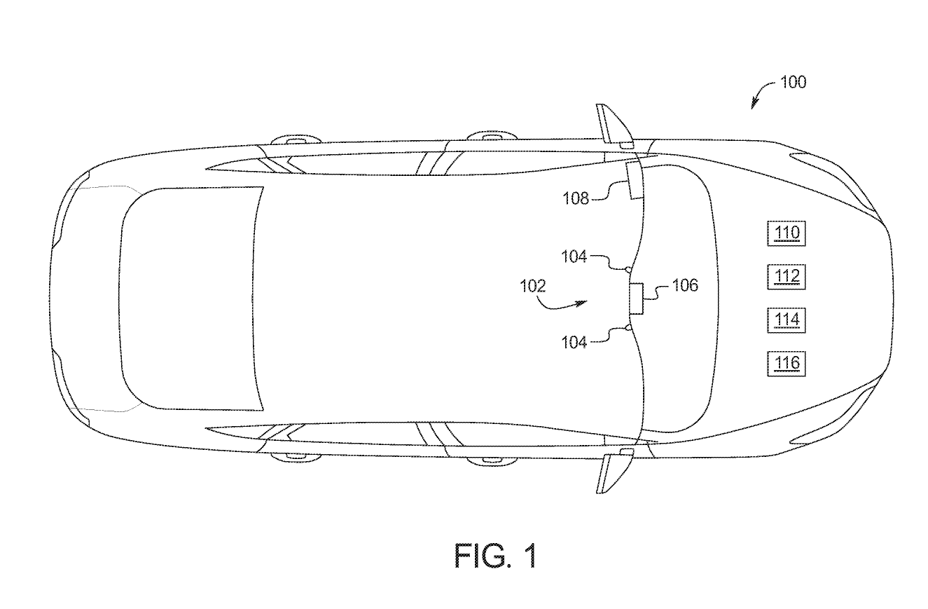

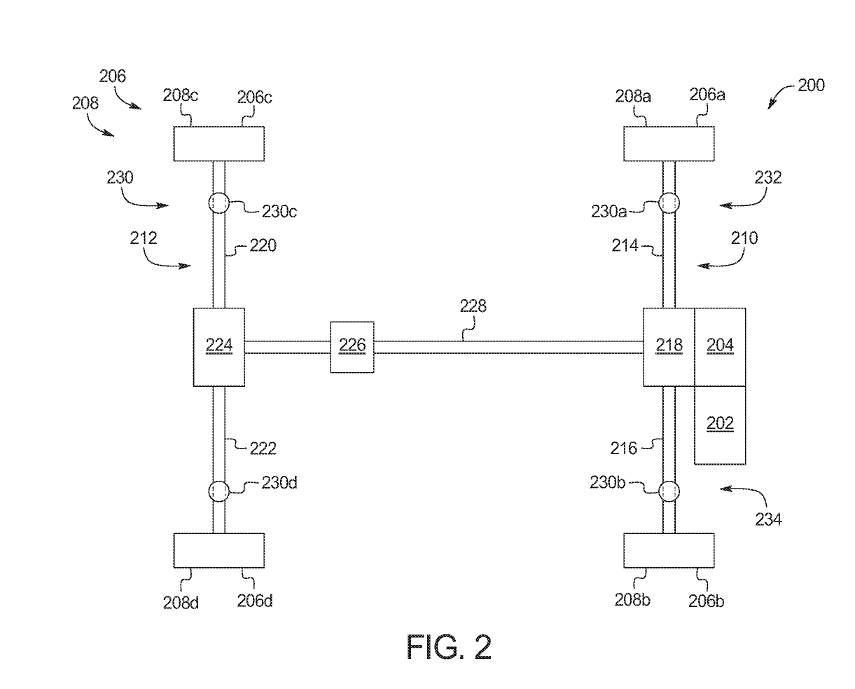

Turning to the figures, FIG. 1 illustrates an example off-road vehicle 100 in accordance with the teachings disclosed herein. The off-road vehicle 100 may be a standard gasoline powered vehicle, a hybrid vehicle, an electric vehicle, a fuel cell vehicle, and/or any other mobility implement type of off-road vehicle. The off-road vehicle 100 includes parts related to mobility (e.g., a powertrain 200, an engine 202, a transmission 204, a suspension 230, wheels 206, etc. of FIG. 2). The off-road vehicle 100 may be non-autonomous, semi-autonomous (e.g., some routine motive functions controlled by the off-road vehicle 100), or autonomous (e.g., motive functions are controlled by the off-road vehicle 100 without direct driver input).

In the illustrated example, the off-road vehicle 100 includes an infotainment head unit 102 that provides an interface between the off-road vehicle 100 and a user (e.g., a driver, another vehicle occupant). The infotainment head unit 102 includes digital and/or analog interfaces to receive input from and display information for the user(s). For example, the infotainment head unit 102 includes one or more input devices 104 (e.g., a control knob, an instrument panel, a digital camera for image capture and/or visual command recognition, a touch screen, an audio input device (e.g., cabin microphone), buttons, a touchpad, etc.) that receives information and/or command(s) from a user of the off-road vehicle 100. Further, the information head unit 102 includes one or more output devices to present infotainment to the user(s) of the off-road vehicle 100. For example, the output devices may include instrument cluster outputs (e.g., dials, lighting devices), actuators, a display 106 (e.g., a heads-up display, a center console display such as a liquid crystal display (LCD), an organic light emitting diode (OLED) display, a flat panel display, a solid state display, etc.), and/or a speaker 108. For example, the display 106 and/or the speaker 108 presents instructions to the driver to adjust a setting of the off-road vehicle 100, and the input devices 104 enable the driver to adjust the setting of the off-road vehicle 100. Further, in the illustrated example, the infotainment head unit 102 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). The infotainment head unit 102 may display the infotainment system on, for example, the display 106.

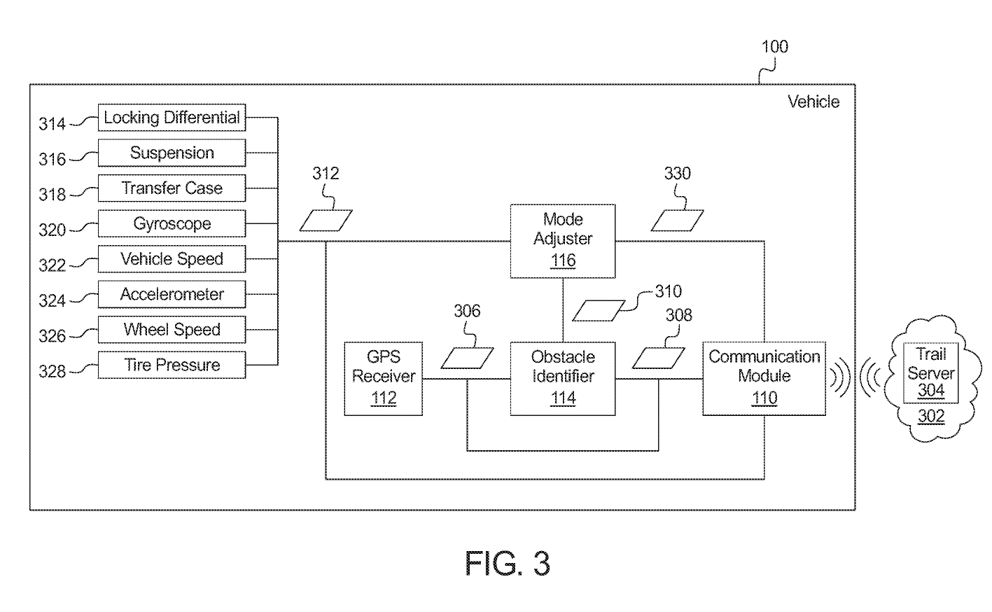

The off-road vehicle 100 of the illustrated example also includes a communication module 110 for communication with a remotely located network (e.g., a network 302 of FIG. 3) and/or server (e.g., a trail server 304 of FIG. 3). The communication module 110 includes wired or wireless network interfaces to enable communication with external networks. The communication module 110 also includes hardware (e.g., processors, memory, storage, antenna, etc.) and software to control the wired or wireless network interfaces. In the illustrated example, the communication module 110 includes one or more communication controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); Near Field Communication (NFC); local area wireless network (including IEEE 802.11a/b/g/n/ac or others), dedicated short range communication (DSRC), and Wireless Gigabit (IEEE 802.11ad), etc.). In some examples, the communication module 110 includes a wired or wireless interface (e.g., an auxiliary port, a Universal Serial Bus (USB) port, a Bluetooth® wireless node, etc.) to communicatively couple with a mobile device (e.g., a smart phone, a smart watch, a tablet, etc.). In such examples, the off-road vehicle 100 may communicated with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

Further, the off-road vehicle 100 includes a global positioning system (GPS) receiver 112 to facilitate monitoring of a location of the off-road vehicle 100. For example, the GPS receiver 112 receives a signal from a global positioning system to monitor and/or determine the location of the off-road vehicle 100. For example, the GPS receiver 112 enables identification of the location of the off-road vehicle 100 on a map of an off-road trail.

As illustrated in FIG. 1, the off-road vehicle 100 also includes an obstacle identifier 114 and a mode adjuster 116. The obstacle identifier 114 determines whether the off-road vehicle 100 is on an off-road trail, for example, by comparing the location of the off-road vehicle 100 to location(s) and corresponding map(s) of off-road trail(s). Upon detecting that the off-road vehicle 100 is on an off-road trail, the obstacle identifier 114 identifies obstacles of the off-road trail and their location on the map of the off-road trail. The obstacle identifier 114 also detects an upcoming obstacle that the off-road vehicle 100 is approaching based upon the location of the off-road vehicle 100 on the map of the off-road trail.

The mode adjuster 116 identifies a type of the upcoming obstacle. For example, the mode adjuster 116 determines whether the upcoming obstacle is a hill, loose sand, a mud pit, a lateral incline, etc. Further, the mode adjuster 116 identifies characteristic(s) of the upcoming obstacle. For example, if the mode adjuster 116 determines the upcoming obstacle is a hill, the mode adjuster 116 determines characteristic(s) of the hill such as a length, a height, an incline angle, etc. If the mode adjuster 116 determines the upcoming object is a mud pit, the mode adjuster 116 determines characteristic(s) of the mud pit such as a size, a width, a length, a depth, a viscosity, etc. If the mode adjuster 116 determines the upcoming object is a lateral incline, the mode adjuster 116 determines characteristic(s) of the lateral incline such as a length, a height, an angle, etc.

In some examples, the mode adjuster 116 also identifies current vehicle settings of the off-road vehicle 100. For example, the mode adjuster 116 a current vehicle speed, current setting(s) of one or more vehicle tires (e.g., tires 208 of FIG. 8), current setting(s) of one or more locking differentials (e.g., a locking differential 218 of FIG. 2, a locking differential 224 of FIG. 2), current setting(s) of a suspension (e.g., a suspension 230 of FIG. 2), a current setting of a transfer case (e.g., a transfer case 226 of FIG. 2), etc.

Based upon the characteristics of the upcoming obstacle(s) of the off-road trail and/or the vehicle setting(s), the mode adjuster 116 determines vehicle settings (e.g., a vehicle speed, a tire pressure, a locking differential setting, a suspension setting, a transfer case setting, etc.) that facilitate the off-road vehicle 100 in driving through, over, around and/or past the upcoming obstacle(s). In some examples, the mode adjuster 116 presents the vehicle settings to the driver via the display 106 and/or the speaker 108 of the off-road vehicle 100 to facilitate the driver in adjusting the vehicle settings via the input devices 104 of the off-road vehicle 100. Additionally or alternatively, the mode adjuster 116 autonomously adjusts the vehicle settings upon determining the vehicle settings that correspond to the characteristics of the upcoming obstacle(s).

FIG. 2 illustrates a powertrain 200 of the off-road vehicle 100. The powertrain 200 include components of the off-road vehicle 100 that generate power and transfer that power onto the surface along which the off-road vehicle 100 travels to propel the off-road vehicle 100 along that surface. As illustrated in FIG. 2, the powertrain 200 includes an engine 202, a transmission 204, and wheels 206. The engine 202 converts stored energy (e.g., fuel, electrical energy) into mechanical energy to propel the off-road vehicle 100. For example, the engine 202 may include an internal combustion engine, an electric motor, and/or a combination thereof. The transmission 204 controls an amount of power generated by the engine 202 that is transferred to other components of the powertrain 200 (e.g., the wheels 206), for example, to increase a torque and/or to reduce a wheel speed. For example, the transmission 204 includes a gearbox that controls the amount of power transferred to the wheels 206 of the off-road vehicle 100.

The wheels 206 of the off-road vehicle 100 engage the surface along which the off-road vehicle 100 travels to propel the off-road vehicle 100 along the surface. In the illustrated example, the wheels 206 include a wheel 206a (e.g., a first wheel, a front driver-side wheel), a wheel 206b (e.g., a second wheel, a front passenger-side wheel), a wheel 206c (e.g., a third wheel, a rear driver-side wheel), and a wheel 206d (e.g., a fourth wheel, a rear passenger-side wheel). Further, the wheels 206 have respective tires 208 that engage the surface along which the off-road vehicle 100 travels. For example, the tires 208 are inflated with a gas (e.g., air) to reduce weight of the wheels 206 and/or to reduce friction between the wheels 206 and the surface. In the illustrated example, the tires 208 include a tire 208a (e.g., a first tire, a front driver-side tire), a tire 208b (e.g., a second tire, a front passenger-side tire), a tire 208c (e.g., a third tire, a rear driver-side tire), and a tire 208d (e.g., a fourth tire, a rear passenger-side tire).

Additionally, the powertrain 200 of the illustrated example includes an axle 210 (e.g., a first axle, a front axle) and an axle 212 (e.g., a second axle, a rear axle). The axle 210 includes a shaft 214 (e.g., a first shaft, a front driver-side shaft) and a shaft 216 (e.g., a second shaft, a front passenger-side shaft) that are coupled together via a locking differential 218 (e.g., a first locking differential, a front locking differential). As illustrated in FIG. 2, the wheel 206a is coupled to the shaft 214 of the axle 210, and the wheel 206b is coupled to the shaft 216 of the axle 210. The locking differential 218 (e.g., a differential lock, a locker) controls the shaft 214 and the shaft 216 of the axle 210 to enable the wheel 206a and the wheel 206b to rotate at different rotational speeds and/or to cause the wheel 206a and the wheel 206b to rotate at a same rotational speed. For example, when the locking differential 218 (e.g., a mechanical locking differential, an electronic locking differential) is in an off-setting, the locking differential 218 enables the shaft 214 and the shaft 216 and, thus, the wheel 206a and the wheel 206b to rotate at different rotational speeds relative to each other. When the locking differential 218 is in an on-setting, the locking differential causes the shaft 214 and the shaft 216 and, thus, the wheel 206a and the wheel 206b to rotate together at same rotational speed relative to each other.

Similarly, the axle 212 includes a shaft 220 (e.g., a third shaft, a rear driver-side shaft) and a shaft 222 (e.g., a fourth shaft, a rear passenger-side shaft) that are coupled together via a locking differential 224 (e.g., a second locking differential, a rear locking differential). As illustrated in FIG. 2, the wheel 206c is coupled to the shaft 220 of the axle 212, and the wheel 206d is coupled to the shaft 222 of the axle 212. The locking differential 224 (e.g., a differential lock, a locker) controls the shaft 220 and the shaft 222 of the axle 212 to enable the wheel 206c and the wheel 206d to rotate at different rotational speeds and/or to cause the wheel 206c and the wheel 206d to rotate at a same rotational speed. For example, when the locking differential 224 (e.g., a mechanical locking differential, an electronic locking differential) is in an off-setting, the locking differential 224 enables the shaft 220 and the shaft 222 and, thus, the wheel 206c and the wheel 206d to rotate at different rotational speeds relative to each other. When the locking differential 224 is in an on-setting, the locking differential causes the shaft 220 and the shaft 222 and, thus, the wheel 206c and the wheel 206d to rotate together at same rotational speed relative to each other.

The powertrain 200 of the illustrated example also includes a transfer case 226 that transmits power from the transmission 204 to the axle 210 and the axle 212 via a driveshaft 228. In some examples, the transfer case 226 rotatably couples the axle 210 and the axle 212 together such that the axle 210 and the axle 212 rotate synchronously. Further, in some examples, the transfer case 226 includes one or more low range gears to increase the torque available to the axle 210 and the axle 212. For example, the transfer case 226 includes a high setting at which the transfer case 226 enables the axle 210 and the axle 212 to rotate at high rotational speeds. The transfer case 226 includes a low setting at which the transfer case 226 reduces rotational speeds at which the axle 210 and the axle 212 may rotate to increase the torque available to the axle 210 and the axle 212. The transfer case 226 includes a high-lock setting at which the transfer case 226 locks rotation of the axle 210 and the axle 212 together and enables the axle 210 and the axle 212 to rotate at a high rotational speed. Further, the transfer case 226 includes a low-lock setting at which the transfer case 226 locks rotation of the axle 210 and the axle 212 together and reduces the rotational speed to increase the available torque.

As illustrated in FIG. 2, the powertrain 200 also includes a suspension 230. For example, the suspension 230 (e.g., air suspension, electromagnetic suspension, etc.) maintains contact between the wheels 206 and the surface along which the off-road vehicle 100 travels to enable the off-road vehicle 100 to propel along the surface. In the illustrated example, the suspension 230 includes a suspension 230a (e.g., a first suspension, a front driver-side suspension), a suspension 230b (e.g., a second suspension, a front passenger-side suspension), a suspension 230c (e.g., a third suspension, a rear driver-side suspension), and a suspension 230d (e.g., a fourth suspension, a rear passenger-side suspension). For example, the suspension 230 includes a high setting in which a distance between a vehicle body and the axle 210 and/or the axle 212 is increased. The suspension 230 also includes a low setting in which the distance between the vehicle body and the axle 210 and/or the axle 212 is reduced. Further, in the illustrated example, the suspension 230a and the suspension 230c are operatively coupled to form a driver-side suspension 232, and the the suspension 230b and the suspension 230d are operatively coupled to form a passenger-side suspension 234.

FIG. 3 is a block diagram of an example vehicle settings adjustment system 300 of the off-road vehicle 100. As illustrated in FIG. 3, the off-road vehicle 100 includes the communication module 110, the GPS receiver 112, the obstacle identifier 114, and the mode adjuster 116.

The communication module 110 wirelessly communicates with a network 302. For example, the network 302 is a public network, such as the Internet; a private network, such as an intranet; or combinations thereof, and may utilize a variety of networking protocols now available or later developed including, but not limited to, TCP/IP-based networking protocols. As illustrated in FIG. 3, the network 302 includes a trail server 304 collects, stores, and provides information related to off-road trail(s) on which the off-road vehicle 100 may travel. For example, the trail server 304 stores a map of an off-road trail on which the off-road vehicle 100 is located and locations and characteristics of obstacles of the off-road trail. In some examples, the trail server updates the map (e.g., updates locations and/or characteristics of obstacles) based upon information collected from users of the off-road trail (e.g., via crowd-sourcing).

The trail server 304 of the illustrated example includes wired or wireless network interfaces to enable communication with the communication module 110 of the off-road vehicle 100. The trail server 304 also includes hardware (e.g., processors, memory, storage, antenna, etc.) and software to control the wired or wireless network interfaces. For example, the trail server 304 includes one or more communication controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); Near Field Communication (NFC); local area wireless network (including IEEE 802.11a/b/g/n/ac or others), dedicated short range communication (DSRC), and Wireless Gigabit (IEEE 802.11ad), etc.).

In the illustrated example, the obstacle identifier 114 collects location data 306 of the off-road vehicle 100 via the GPS receiver 112 to determine a location of the off-road vehicle 100. Further, the obstacle identifier 114 collects map data 308 of one or more off-road trails from the trail server 304 via the communication module 110. For example, the map data 308 includes locations, maps, obstacles, and characteristics of obstacles of the off-road trails. Based upon location data 306 and the map data 308, the obstacle identifier 114 determines whether the off-road vehicle 100 is located on an off-road trail. If the off-road vehicle 100 is located on an off-road trail, the obstacle identifier 114 the off-road trail on which the off-road vehicle 100 is located. Further, based upon the location of the off-road vehicle on the map of the off-road trail and the map data 308 that identifies location(s) of one or more obstacles of the off-road trail, the obstacle identifier 114 detects an upcoming obstacle (e.g., a hill, loose sand, a mud hole, a lateral incline, etc.) of the off-road trail for the off-road vehicle 100.

As illustrated in FIG. 3, the mode adjuster 116 collects obstacle data 310 of the upcoming obstacle identified by the obstacle identifier 114. For example, the obstacle data includes a location of the upcoming obstacle on the map and other characteristics of the upcoming obstacle.

Further, the mode adjuster 116 collects vehicle data 312 from one or more sensors of the off-road vehicle 100. In the illustrated example, the mode adjuster 116 collects current settings (e.g., an on-setting, an off-setting) of the locking differential 218 and/or the locking differential 224 that are detected via respective locking differential sensors 314. The mode adjuster 116 collects current settings (e.g., a high setting, a low setting) of the suspension 230a, the suspension 230b, the suspension 230c, the suspension 230d and/or, more generally, the suspension 230 that are detected via respective suspension sensors 316. The mode adjuster 116 collects a current transfer case setting (e.g., a high setting, a high-lock setting, a low setting, a low-lock setting) of the transfer case 226 that is detected via a transfer case sensor 318. The mode adjuster 116 collects a vehicle roll angle and/or a vehicle pitch angle of the off-road vehicle 100 that is detected via a gyroscope 320. In some examples, the mode adjuster 116 collects a vehicle speed of the off-road vehicle 100 that is detected via a vehicle speed sensor 322. Additionally or alternatively, the mode adjuster 116 collects the vehicle speed that is determined based upon measurements detected via an accelerometer 324 of the off-road vehicle 100. Further, the mode adjuster 116 collect the vehicle speed via the GPS receiver. In the illustrated example, the mode adjuster 116 collects wheel speeds of the wheels 206 that are detected via respective wheel speed sensors 326 and collects tire pressure measurements of the tires 208 that are detected via respective tire pressure sensors 328. As illustrated in FIG. 3, the mode adjuster 116 also collects environmental data 330 (e.g., current and/or predicted weather conditions) corresponding to the off-road trail on which the off-road vehicle 100 is located.

In some examples, based upon the location and/or characteristics of the upcoming obstacle, the vehicle data 312, and/or the weather conditions, the mode adjuster autonomously sets and/or adjusts settings of components (e.g., the locking differential 218, the locking differential 224, the transfer case 226, the suspension 230, etc.) and/or a rate of travel (e.g., a vehicle speed, velocity, acceleration, deceleration, etc.) of the off-road vehicle 100. For example, the mode adjuster 116 sets the locking differential 218 and/or the locking differential 224 in a first setting, the suspension 230 in a second setting, the transfer case 226 in a third setting, and/or a vehicle speed at a fourth setting based upon the upcoming obstacle identified by the obstacle identifier 114. In some such examples, the mode adjuster 116 sets the locking differential 218 in an off-setting to enable the wheel 206a and the wheel 206b to rotate asynchronously relative to each other. In other such examples, the mode adjuster 116 sets the locking differential 218 in an on-setting to cause the wheel 206a and the wheel 206b to rotate synchronously relative to each other.

Additionally or alternatively, the mode adjuster 116 presents the vehicle settings to which its components are to be set to the driver via the display 106 and/or the speaker 108. For example, the driver may adjust vehicle setting(s) (e.g., of the locking differential 218, the locking differential 224, the transfer case 226, the suspension 230) via one or more of the input devices 104 of the infotainment head unit 102 based on the information presented by the mode adjuster via the display 106 and/or the speaker 108. In some examples, the driver may adjust a tire pressure of one or more of the tires based prior to driving on the off-road track based upon the information provided by the instructions provided by the mode adjuster 116.

In response to the obstacle identifier 114 identifying that the upcoming obstacle is a hill, the mode adjuster 116 collects the location of the off-road vehicle 100. The mode adjuster 116 also collects the vehicle data 312 that is associated with a hill and includes wheel speeds of the wheels 206, the vehicle speed, and/or the vehicle pitch angle that indicates an incline angle of the hill. Further, the mode adjuster 116 collects the obstacle data 310 associated with the hill that includes a location, a length, and/or an incline angle. Based upon the collected characteristics of the off-road vehicle 100 and the hill, the mode adjuster 116 determines to and presents and/or autonomously sets a vehicle speed that enables the off-road vehicle 100 to climb the hill and deters the off-road vehicle 100 from rolling over upon climbing the hill.

Further, in response to the obstacle identifier 114 identifying that the upcoming obstacle is loose sand, the mode adjuster 116 collects the location of the off-road vehicle 100. The mode adjuster 116 also collects the vehicle data 312 that is associated with loose sand and includes tire pressure measurements of the tires 208 and collects the obstacle data 310 associated with the loose sand that includes its location on the off-road trail. Based upon the collected characteristics of the off-road vehicle 100 and the loose sand, the mode adjuster 116 determines to and presents a tire pressure for the tires 208 (e.g., a reduced tire pressure) that enables the off-road vehicle 100 to traverse through the loose sand.

In response to the obstacle identifier 114 identifying that the upcoming obstacle is a mud hole, the mode adjuster 116 collects the location of the off-road vehicle 100. The mode adjuster 116 also collects the vehicle data 312 that is associated with a mode hole and includes the current setting of the locking differential 218, the current setting of the locking differential 224, the current setting of the transfer case 226, and/or the current setting of the suspension 230. Additionally, the mode adjuster 116 collects the obstacle data 310 associated with the mud hole that includes a location, a length, a width, a depth and/or a mud viscosity. Based upon the collected characteristics of the off-road vehicle 100 and the mud hole, the mode adjuster 116 determines to and autonomously sets and/or presents instructions to set the locking differential 218 in an on-setting, the locking differential 224 in an on-setting, the transfer case 226 in a high-lock setting, and the suspension 230 in a high setting.

Further, in some examples, the obstacle identifier 114 identifies that the upcoming obstacle is a lateral incline that causes the driver-side or the passenger-side of the off-road vehicle 100 to be elevated above the other of the driver-side or the passenger-side. In response to the obstacle identifier 114 identifying that the upcoming obstacle is a lateral incline, the mode adjuster 116 collects the location of the off-road vehicle 100. The mode adjuster 116 also collects the vehicle data 312 that is associated with a lateral hill and includes the vehicle speed, the current setting of the locking differential 218, the current setting of the locking differential 224, the current setting of the transfer case 226, the current setting of the suspension 230, and/or the current roll angle of the off-road vehicle 100. Additionally, the mode adjuster 116 collects the obstacle data 310 associated with the lateral incline that includes a location, a length, and/or an incline. Based upon the collected characteristics of the off-road vehicle 100 and the lateral incline, the mode adjuster 116 determines to and autonomously sets and/or presents instructions to set the locking differential 218 in an on-setting and the locking differential 224 in an on-setting. In some examples, the mode adjuster 116 determines to and autonomously sets and/or presents instructions to set the suspension 230 in a low setting. Alternatively, in some examples in which the driver-side suspension 232 and the passenger-side suspension 234 may be set independently of each other, the mode adjuster 116 determines to and autonomously sets and/or presents instructions to set one of the driver-side suspension 232 and the passenger-side suspension 234 in a low setting and the other of the driver-side suspension 232 and the passenger-side suspension 234 in a high setting based upon the angle of the lateral incline.

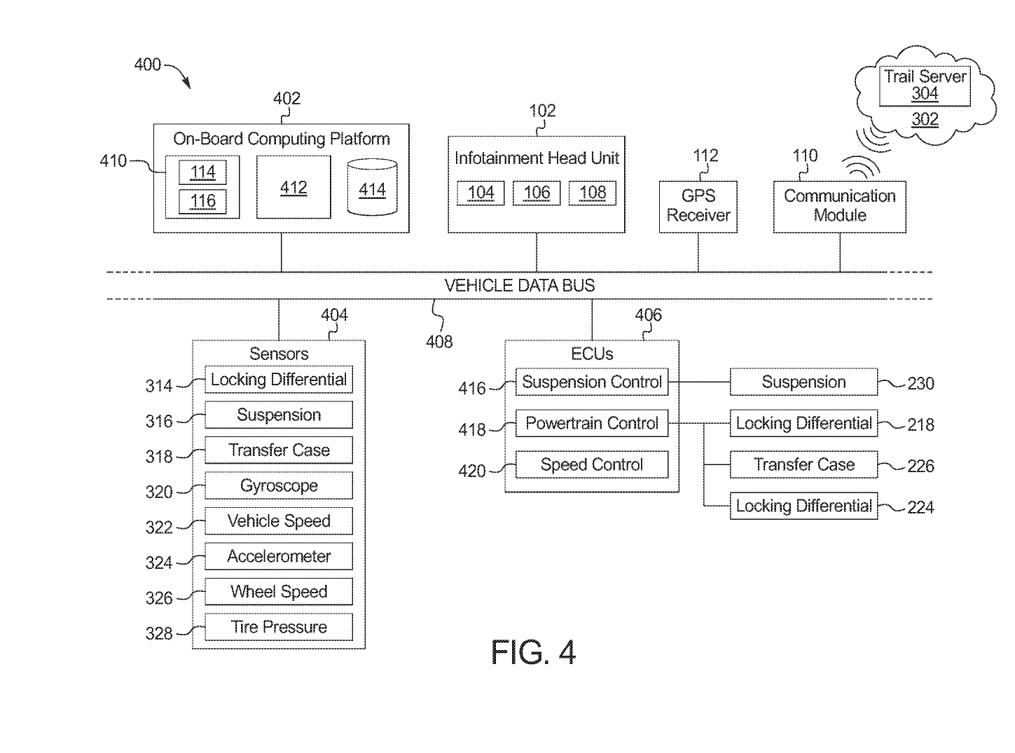

In the illustrated example, the obstacle identifier 114 and the mode adjuster 116 that identify upcoming obstacles and adjust settings of the vehicle components, respectively, are located within the off-road vehicle 100 (e.g., a processor 410 of FIG. 4). In other examples, the trail server 304 identifies upcoming obstacles of the off-road vehicle 100 and sends signals to adjust settings of the off-road vehicle 100. In such examples, the trail server 304 receives the location data 306 and the vehicle data 312 of the off-road vehicle 100 via the communication module 110. The trail server 304 identifies upcoming obstacles and determines vehicle settings for the upcoming obstacles based upon the location data 306, the map data 308, the vehicle data 312, and/or the environmental data 330. Further, the trail server 304 sends signal(s) to the off-road vehicle 100 to adjust the vehicle settings of the off-road vehicle 100.

FIG. 4 is a block diagram of electronic components 400 of the off-road vehicle 100. As illustrated in FIG. 4, the electronic components 400 include an on-board computing platform 402, the infotainment head unit 102, the GPS receiver 112, the communication module 110, sensors 404, electronic control units (ECUs) 406, and a vehicle data bus 408.

The on-board computing platform 402 includes a microcontroller unit, controller or processor 410; memory 412; and a database 414. In some examples, the processor 410 of the on-board computing platform 402 is structured to include the example obstacle identifier 114 and/or the example mode adjuster 116. Alternatively, in some examples, the obstacle identifier 114 and/or the example mode adjuster 116 are incorporated into another electronic control unit (ECU) with its own processor 410 and memory 412. In some examples, the database 414 stores characteristics of off-road trail(s) (e.g., maps, obstacles, obstacle characteristics, etc.) that are collected by the obstacle identifier 114 to identify upcoming obstacle(s) for the off-road vehicle 100 an/or by the mode adjuster 116 to adjust setting(s) of the off-road vehicle 100.

The processor 410 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 412 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 412 includes multiple kinds of memory, particularly volatile memory and non-volatile memory.

The memory 412 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 412, the computer readable medium, and/or within the processor 410 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 404 are arranged in and around the off-road vehicle 100 to monitor properties of the off-road vehicle 100 and/or an environment in which the off-road vehicle 100 is located. One or more of the sensors 404 may be mounted to measure properties around an exterior of the off-road vehicle 100. Additionally or alternatively, one or more of the sensors 404 may be mounted inside a cabin of the off-road vehicle 100 or in a body of the off-road vehicle 100 (e.g., an engine compartment, wheel wells, etc.) to measure properties in an interior of the off-road vehicle 100. For example, the sensors 404 include accelerometers, odometers, tachometers, pitch and yaw sensors, wheel speed sensors, microphones, tire pressure sensors, biometric sensors and/or sensors of any other suitable type. In the illustrated example, the sensors 404 include the locking differential sensors 314, the suspension sensors 316, the transfer case sensor 318, the gyroscope 320, the vehicle speed sensor 322, the accelerometer 324, the wheel speed sensors 326, and the tire pressure sensors 328.

The ECUs 406 monitor and control the subsystems of the off-road vehicle 100. For example, the ECUs 406 are discrete sets of electronics that include their own circuit(s) (e.g., integrated circuits, microprocessors, memory, storage, etc.) and firmware, sensors, actuators, and/or mounting hardware. The ECUs 406 communicate and exchange information via a vehicle data bus (e.g., the vehicle data bus 408). Additionally, the ECUs 406 may communicate properties (e.g., status of the ECUs 406, sensor readings, control state, error and diagnostic codes, etc.) to and/or receive requests from each other. For example, the off-road vehicle 100 may have seventy or more of the ECUs 406 that are positioned in various locations around the off-road vehicle 100 and are communicatively coupled by the vehicle data bus 408.

In the illustrated example, the ECUs 406 include a suspension control module 416, a powertrain control module 418, and a speed control unit 420. The suspension control module 416 controls the suspension 230a, the suspension 230b, the suspension 230c, the suspension 230d and, more generally, the suspension 230 of the off-road vehicle 100. For example, the suspension control module 416 controls the suspension 230 via one or more corresponding suspension controllers. In some examples, the mode adjuster 116 sends a signal to the suspension control module 416 to adjust setting(s) of the suspension 230 of the off-road vehicle 100. Further, the powertrain control module 418 of the illustrated example controls the locking differential 218, the locking differential 224, and the transfer case 226. For example, the powertrain control module 418 controls the locking differential 218 and/or the locking differential 224 via one or more corresponding locking differential controllers and controls the transfer case 226 via a corresponding transfer case controller. In some examples, the mode adjuster 116 sends a signal to the powertrain control module 418 to adjust setting(s) of the locking differential 218, the locking differential 224, and the transfer case 226. Additionally, the speed control unit 420 of the illustrated example includes autonomously controls a speed, acceleration, and/or deceleration of the off-road vehicle 100. For example, the mode adjuster 116 sends a signal to the speed control unit 420 to adjust the speed of the off-road vehicle 100.

The vehicle data bus 408 communicatively couples the infotainment head unit 102, the communication module 110, the GPS receiver 112, the on-board computing platform 402, the sensors 404, and the ECUs 406. In some examples, the vehicle data bus 408 includes one or more data buses. The vehicle data bus 408 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

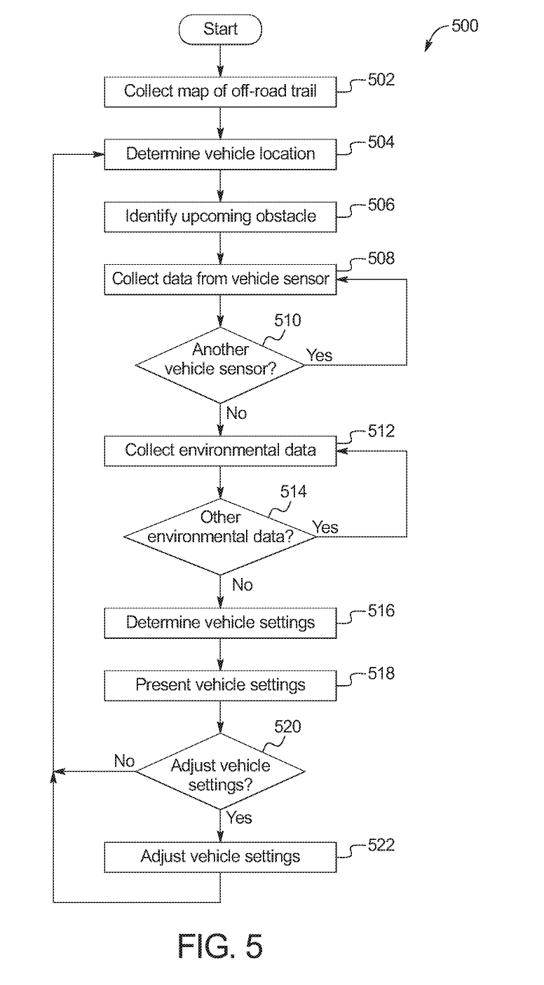

FIG. 5 is a flowchart of an example method 500 to adjust settings of an off-road vehicle. The flowchart of FIG. 5 is representative of machine readable instructions that are stored in memory (such as the memory 412 of FIG. 4) and include one or more programs which, when executed by a processor (such as the processor 410 of FIG. 4), cause the off-road vehicle 100 to implement the example obstacle identifier 114 and/or the example mode adjuster 116 of FIGS. 1 and 3-4. While the example program is described with reference to the flowchart illustrated in FIG. 5, many other methods of implementing the example obstacle identifier 114 and/or the example mode adjuster 116 may alternatively be used. For example, the order of execution of the blocks may be rearranged, changed, eliminated, and/or combined to perform the method 500. Further, because the method 500 is disclosed in connection with the components of FIGS. 1-4, some functions of those components will not be described in detail below.

Initially, at block 502, the obstacle identifier 114 collects a map of an off-road trail on which the off-road vehicle 100 is travelling or is to travel. For example, the obstacle identifier 114 collects the map data 308 from the trail server 304 via the communication module 110 of the off-road vehicle 100. At block 504, the obstacle identifier 114 determines a location of the off-road vehicle 100 relative to the map of the off-road trail. For example, the obstacle identifier 114 collects the location data 306 via the GPS receiver 112. At block 506, the obstacle identifier 114 determines an upcoming obstacle of the off-road trail for the off-road vehicle 100 based upon the location of the off-road vehicle 100 and the map of the off-road trail. Further, in some examples, the obstacle identifier 114 sends the obstacle data 310 of the upcoming obstacle to the mode adjuster 116.

At block 508, the mode adjuster 116 collects data from one of the sensors 404 of the off-road vehicle 100. For example, the mode adjuster 116 collects the vehicle data 312 that identifies a current setting of the locking differential 218 and is detected via one of the locking differential sensors 314. At block 510, the mode adjuster 116 determines whether there is other data to collect from the sensors 404. In response to the mode adjuster 116 determining that there is other data to collect from the sensors 404, the method 500 returns to block 508. For example, the method 500 repeats block 508 to collect the current setting of the locking differential 224 via the other of the locking differential sensors 314, the current setting of the suspension 230 via the suspension sensors 316, the current setting of the transfer case 226 via the transfer case sensor 318, the current roll and/or pitch angle of the off-road vehicle 100 via the gyroscope 320, the vehicle speed via the vehicle speed sensor 322, the current vehicle speed and/or acceleration via the accelerometer 324, the current wheel speed of the wheels 26 via the wheel speed sensors 326, and/or the current tire pressure of the tires 208 via the tire pressure sensors 328. In response to the mode adjuster 116 determining that there is no other data to collect from the sensors 404, the method 500 proceeds to block 512.

At block 512, the mode adjuster 116 collects environmental data (e.g., weather conditions) of the off-road trail and/or the off-road vehicle 100. For example, the mode adjuster 116 collects the environmental data 330 from the trail server 304 via the communication module 110. At block 514, the mode adjuster 116 determines whether there is other environmental data to collect. In response to the mode adjuster 116 determining that there is other data to collect from the sensors 404, the method 500 returns to block 512. Otherwise, in response to the mode adjuster 116 determining that there is no other environmental data to collect, the method 500 proceeds to block 516.

At block 516, the mode adjuster 116 determines settings of components of the off-road vehicle 100 (e.g., the tires 208, the locking differential 218, the locking differential 224, the transfer case 226, the suspension 230) that enable the off-road vehicle 100 to traverse through, over, around and/or past the upcoming obstacle. At block 518, the mode adjuster 116 presents (e.g., via the display 106 and/or the speaker 108) the target settings of the vehicle components to the driver of the off-road vehicle 100 to facilitate the driver in adjusting the settings of the vehicle components (e.g., via one or more input devices 104) to the targeted settings. At block 520, the mode adjuster 116 determines whether to adjust the settings of the vehicle components of the off-road vehicle 100. For example, the mode adjuster 116 determines whether to adjust the settings of the vehicle components by comparing the current settings detected at block 508 to the target settings determined at block 516. In response to the mode adjuster 116 determining to not adjust the settings of the vehicle components, the method 500 returns to block 504. Otherwise, in response to the mode adjuster 116 determining to adjust one or more of settings of the vehicle components, the method 500 proceeds to block 522 at which the mode adjuster 116 autonomously adjusts and/or sets the vehicle settings to the target settings determined at block 516.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a locking differential;
a suspension;
a communication module to collect a map of an off-road trail;
a GPS receiver to determine a vehicle location;
an obstacle identifier to detect, via a processor, an upcoming obstacle based upon the vehicle location on the map; and
a mode adjuster to set the locking differential in a first setting and the suspension in a second setting based upon the upcoming obstacle.

2. The vehicle of claim 1, wherein the mode adjuster sets the locking differential in an on-setting to cause vehicle wheels to rotate synchronously or an off-setting to enable the vehicle wheels to rotate asynchronously.

3. The vehicle of claim 1, further including a display, a speaker, and an input device, wherein the mode adjuster instructs a driver via at least one of the display and the speaker to adjust at least one of the locking differential and the suspension via the input device.

4. The vehicle of claim 1, further including:
a transfer case for transferring power from a transmission to axles; and
a transfer case sensor to determine a current transfer case setting.

5. The vehicle of claim 4, wherein, when the obstacle identifier identifies that the upcoming obstacle is a mud hole, the settings adjuster sets the suspension setting in a high setting, the locking differential in an on-setting, and the transfer case in a high-lock setting.

6. The vehicle of claim 1, wherein the suspension includes a driver-side suspension and a passenger-side suspension to enable the mode adjuster to set the driver-side suspension and the passenger-side suspension asymmetrically.

7. The vehicle of claim 6, wherein, when the obstacle identifier identifies that the upcoming obstacle is a lateral incline, the mode adjuster sets the locking differential in an on-setting, one of the driver-side suspension and the passenger-side suspension in a high setting, and the other of the driver-side suspension and the passenger-side suspension in a low setting based upon an angle of the lateral incline.

8. The vehicle of claim 7, wherein the settings adjuster further sets the locking differential and the suspension based upon a vehicle speed.

9. The vehicle of claim 8, further including a gyroscope to determine at least one of a vehicle pitch angle and a vehicle roll angle.

10. The vehicle of claim 1, further including a suspension sensor to detect a current suspension setting of the suspension and a locking differential sensor to detect a current locking differential setting of the locking differential.

11. The vehicle of claim 1, further including at least one of a vehicle speed sensor and an accelerometer to detect a vehicle speed.

12. The vehicle of claim 1, wherein the mode adjuster sets a vehicle speed based upon the upcoming obstacle.

13. The vehicle of claim 1, further including wheel speed sensors to detect wheel speeds of wheels and tire pressure sensors to detect tire pressures of tires.

14. The vehicle of claim 1, wherein the communication module further collects weather conditions corresponding to the off-road trail.

15. A method for adjusting vehicle settings of off-road vehicles, the method comprising:
collecting a map of an off-road trail via a communication module of a vehicle;
determining a vehicle location via a GPS receiver;
detecting, via a processor, an upcoming obstacle based upon the vehicle location on the map; and
setting, via the processor, a locking differential in a first setting and a suspension in a second setting based upon the upcoming obstacle.

16. The method of claim 15, further setting, via the processor, a transfer case in a third setting and set a vehicle speed at a fourth setting based upon the upcoming obstacle.

17. A system comprising:
a vehicle including a locking differential, a suspension, a communication module, and a processor; and
a trail server to:
determine a vehicle location on a map of an off-road trail;
detect an upcoming obstacle based upon the vehicle location; and
send, based upon the upcoming obstacle, a signal to the communication module to cause the processor to set the locking differential in a first setting and the suspension in a second setting.

18. The system of claim 17, wherein the trail server stores the map of the off-road trail and locations and characteristics of obstacles of the off-road trail.

19. The system of claim 18, wherein the trail service updates the map and the characteristics of the off-road trail based upon information received from users of the off-road trail.

20. The system of claim 17, wherein the signal sent by the trail server is to further cause the processor to set a transfer case in a third setting and set a vehicle speed at a fourth setting based upon the upcoming obstacle.
